(19) United States
(12) Patent Application Publication
(10) Pub. No.: US 2012/0198180 A1
(43) Pub. Date: Aug. 2, 2012

(54) NONVOLATILE MEMORY SYSTEM AND FLAG DATA INPUT/OUTPUT METHOD FOR THE SAME

(75) Inventors: Min Su KIM, Ichon-si (KR); Chang Won Yang, Ichon-si (KR)

(73) Assignee: Hynix Semiconductor Inc., Ichon-shi (KR)

(21) Appl. No.: 13/162,651

(22) Filed: Jun. 17, 2011

(30) Foreign Application Priority Data
Jan. 31, 2011 (KR) 10-2011-0009799

(51) Int. Cl. G06F 12/00

(52) U.S. Cl. 711/154; 711/E12.001

(57) ABSTRACT

Various embodiments of a nonvolatile memory system and related methods are disclosed. In one exemplary embodiment, the memory system may include: a memory area including a main memory area and a flag memory area; and an input/output controller configured to receive main data through a main data input line and provide the received main data to a page buffer circuit in response to a main data input control signal. The input/output controller may be further configured to receive flag data through the main data input line and provide the received flag data to the page buffer circuit in response to a flag data input control signal.

### CROSS-REFERENCES TO RELATED APPLICATION

The present application claims priority under 35 U.S.C. §119(a) to Korean Patent Application Number 10-2011-0009799, filed on Jan. 31, 2011, in the Korean Intellectual Property Office, which is incorporated herein by reference in its entirety as if set forth in full.

### BACKGROUND

1. Technical Field

Various embodiments of the present disclosure relate to a semiconductor memory system and related methods. In particular, certain embodiments relate to a nonvolatile memory system and a flag data input/output method for the same.

2. Related Art

Nonvolatile memories, including flash memories, are widely used in mobile multimedia products because, among other reasons, they consume less power, have high resistance to impacts, and enable miniaturization.

Nonvolatile memory systems have evolved from a single level cell to a multi-level cell to increase the degree of integration in its memory area. When data are programmed in a multi-level cell, flag cells are used to store flag information indicating whether memory cells connected to word lines are programmed as most significant bit (MSB) data or least significant bit (LSB) data.

FIG. 1 is a schematic diagram illustrating a configuration of a conventional nonvolatile memory system. As shown in FIG. 1, the nonvolatile memory system 10 may include a memory area 110, an address decoder 120, a page buffer circuit 130, an input/output control circuit 140, a voltage provider 150, a controller 160, and a determination circuit 170.

The memory area 110 is divided into a main memory area 112 and a flag memory area 114. The main memory are 112 includes a plurality of memory cells connected between a word line (not illustrated) and a bit line (not illustrated). Data to be written by a host (not illustrated) are written to the main memory 110, and data requested by a host are read from the main memory 110. The flag memory area 114 includes a plurality of flag cells indicating the program states of the respective memory cells connected to word lines.

The address decoder 120 is configured to select a word line and a bit line of a memory cell that is to be accessed according to an operation mode.

The page buffer circuit 130 is configured to read data from the memory area 110 during a read operation and write data to the memory area 110 during a program operation. The page buffer circuit 130 includes a first page buffer unit PB_M for the main memory area 112 and a second page buffer unit PB_F for the flag memory area 114.

For example, during an MSB program operation, the second page buffer PB_F programs data as flag data in a flag cell connected to a word line selected by the address decoder 120.

The input/output control circuit 140 includes a main input/output control unit 142 and a flag input/output control unit 144. Accordingly, input data D_IN are provided to the main input/output control unit 142 through a main data input line MDIL, and then are written to the main memory area 112 through the first page buffer unit PB_M. The data programmed in the main memory area 112 are latched through the first page buffer unit PB_M and then are outputted through a main data output line MDOL via the main input/output control unit 142.

Input flag data FD_IN are provided to the flag input/output control unit 144 through a flag data input line FDIL, and then are written to the flag memory area 114 through the second page buffer unit PB_F. The data programmed in the flag memory area 114 are latched in the second page buffer unit PB_F and then are provided to the determination circuit 170 through a flag data output line FDOL via the flag input/output control unit 144. The determination circuit 170 receives the data programmed in the flag cell and determines the program state of the main memory area 112.

FIG. 2 is a diagram illustrating an example of the determination circuit 170 of FIG. 1. The determination circuit 170 of FIG. 2 includes a multiplexer 172, an output unit 174, and a determiner 176.

The multiplexer 172 is configured to receive flag output data FD_OUT from the flag input/output control unit 144 and sequentially output the received data to the output unit 174. The output unit 174 is configured to provide the flag output data to the determiner 176 through a global data line.

Based on the flag output data from the flag cell, the determiner 176 determines whether or not the number of data at a preset level is greater than or equal to a threshold value and outputs the determination result as a flag signal F.

As described above, the current nonvolatile memory apparatus includes the main input/output control unit 142, the flag input/output control unit 144, the main data input/output lines MDIL and MDOL, and the flag data input/output lines FDIL and FDOL to perform data input/output operations for the main memory area 112 and the flag memory area 114.

As a result, the degree of integration in the memory apparatus is decreases since the area of the memory apparatus is increased to accommodate the input/output control unit 114, the data input/output lines FDIL and FDOL, and other components used to operate the flag memory area 114. Furthermore, since the main memory area 112 and the flag memory area 114 are individually operated, it may be difficult to optimize the operational efficiency of the nonvolatile memory system.

### SUMMARY

Accordingly, there is a need for an improved memory system that may overcome one or more shortcomings mentioned above.

To attain the advantages and in accordance with the purposes of the invention, as embodied and broadly described herein, one exemplary aspect of the present disclosure may provide a nonvolatile memory system comprising: a memory area including a memory area and a flag memory area; and an input/output controller configured to receive main data through a main data input line and provide the received main data to a page buffer circuit in response to a main data input control signal, the input/output controller further being configured to receive flag data through the main data input line and provide the received flag data to the page buffer circuit in response to a flag data input control signal.

In another exemplary aspect, a nonvolatile memory system may comprise: a controller configured to output a control signal, an address signal, and data according to an operational mode; a memory area controlled by the controller and including a main memory area and a flag memory area; a first page buffer unit connected to the main memory area; a second page buffer unit connected to the flag memory area; and an input/output controller configured to provide main data received through a main data input line to the first page buffer unit and provide flag data received through the main data input line to the second page buffer unit, according to control of the controller.

Some exemplary aspects of the present disclosure may provide an input/output method for flag data in a nonvolatile memory system comprising a main memory area and a flag memory area. The method may comprise: enabling a page buffer circuit in response to a flag data input signal and an address signal, storing flag data inputted through a main data line in the page buffer circuit, and programming the data stored in the page buffer circuit into the flag memory area; and reading the data of the flag memory area in response to a flag data output signal, storing the read data in the page buffer circuit, and outputting state determination data of the flag data according to an amount of current applied to the page buffer circuit.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a schematic diagram illustrating a configuration of a conventional nonvolatile memory system.

FIG. 2 is a schematic diagram illustrating a configuration a determination circuit shown in FIG. 1.

FIG. 3 is a schematic diagram illustrating a configuration of a nonvolatile memory system according to one exemplary embodiment.

FIG. 4 is a schematic diagram illustrating an example of a determination circuit of FIG. 3.

FIG. 5 is a conceptual diagram explaining an exemplary input/output method for flag data according to one exemplary embodiment.

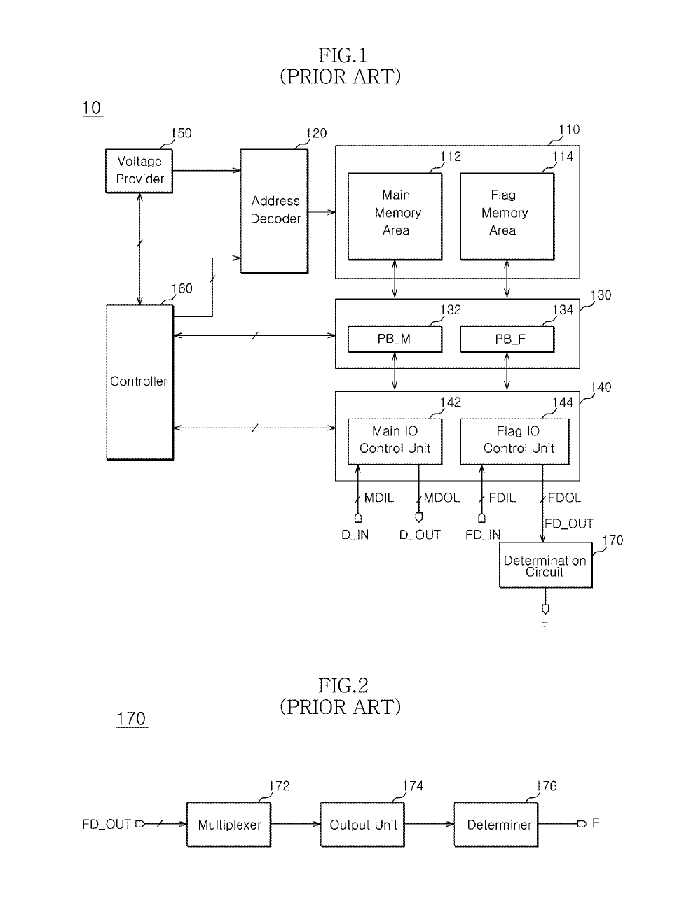

### DETAILED DESCRIPTION

Reference will now be made in detail to the exemplary embodiments consistent with the present disclosure, examples of which are illustrated in the accompanying drawings. Wherever possible, the same reference characters will be used throughout the drawings to refer to the same or like parts.

Hereinafter, a nonvolatile memory system and related input/output methods for flag data will be described. According to one exemplary aspect, various embodiments may be configured such that an input timing of flag data and an input timing of main data in a nonvolatile memory system are different from each other. Since the main data and the flag data are inputted at different timings, the flag data may be inputted, for example, through a main data input line.

Nonetheless, an output timing of main data and an output timing of flag data may be the same. Therefore, as data are stored in a page buffer from a flag cell during the output of the flag data, the state of the flag cell can be determined by comparing an amount of current applied to an output node of the page buffer with a reference value.

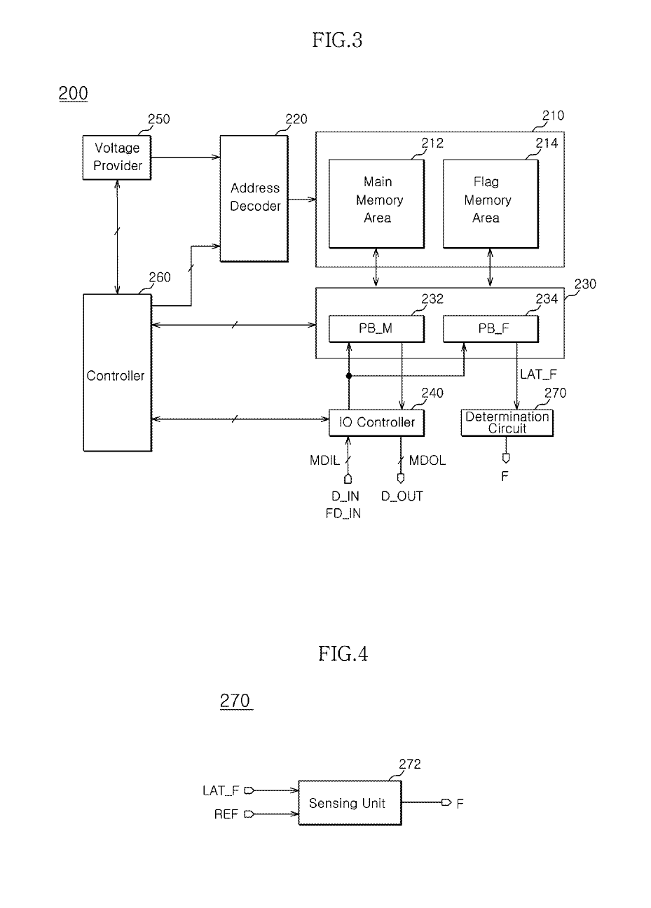

FIG. 3 illustrates an exemplary configuration of a nonvolatile memory system consistent with one exemplary aspect of the present disclosure. As shown in FIG. 3, the nonvolatile memory system 200 may include a memory area 210, an address decoder 220, a page buffer circuit 230, an input/output controller 240, a voltage provider 250, a controller 260, and a determination circuit 270.

The memory area 210 can be divided into a main memory area 212 and a flag memory area 214. The main memory area 212 may include a plurality of nonvolatile memory cells connected between a word line (not illustrated) and a bit line (not illustrated). Similarly, the flag memory area 214 may include a plurality of nonvolatile flag memory cells connected between a word line and a bit line.

In some exemplary embodiments, one or more memory cells may be selectively connected to a single word line. Therefore, when main memory cells connected to a selected word line are programmed, flag memory cells connected to the corresponding word line may be simultaneously programmed to store the states of the main memory cells.

The address decoder 220 may be configured to select which word line and bit line are to be accessed from a plurality of word lines and bit lines based on a row address and a column address. Depending on the operational mode, the address decoder 220 may be configured to supply a first voltage received from the voltage provider 250 to the selected word line and to supply a second voltage received from the voltage provider 250 to an unselected word line.

The page buffer circuit 230 may be controlled by the controller 260 and may include a first page buffer unit PB_M 232 connected to the main memory area 212 and a second page buffer unit PB_F 234 connected to the flag memory area 214. The first page buffer unit 232 may be configured to read main data from, or program main data to, the main memory area 212. The second page buffer unit 234 may be configured to read flag data from, or program main data to, the flag memory area 214.

The input/output controller 240 may be configured to output main data D_OUT, which have been read from the first main buffer unit 232, to outside in response to a main data output control signal. The input/output controller 240 may also be configured to receive main data D_IN in response to a main data input control signal and provide the received main data D_IN to the first page buffer unit 232. The operation of the input/output controller 240 may be performed under the control of the controller 260.

In addition, the input/output controller 240 may be configured to provide flag data FD_IN to the second page buffer unit 234 in response to a flag data input control signal, such that the flag data FD_IN can be programmed in the flag memory area 214 under the control of the controller 260.

In this exemplary nonvolatile memory system 200 having the flag memory area 214, the input operation of the main data D_IN and the input operation of the flag data FD_IN are not performed at the same time. Therefore, the main data input line MDIL may be commonly used to input both the main data D_IN and the flag data FD_IN.

The voltage provider 250 may be configured to generate a necessary voltage according to an operational mode of the nonvolatile memory system 200 and provide the generated voltage to the address decoder 220. The controller 260 may be configured to output an internal control signal according to the operational mode in response to a command provided by a host (not illustrated).

When flag data are latched in the second page buffer unit 234 according to a flag data read command, the determination circuit 270 receives a signal LAT_F applied to an output node of the second page buffer 234, determines the state of the flag data, and outputs determination data F, according to the control of the controller 260. Furthermore, the determination data F may be outputted to the controller 260. Accordingly, the controller 260 may determine the programming state of the main memory area 212 based on the determination result outputted from the determination circuit 270. For this reason, the determination circuit 270 may be designated as a flag data output controller.

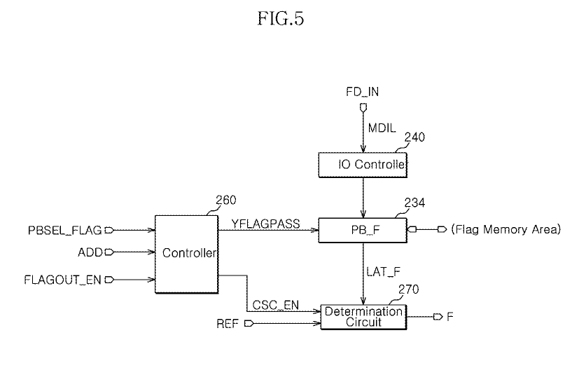

FIG. 4 illustrates an exemplary embodiment of the determination circuit of FIG. 3. The determination circuit 270 may include a sensing unit 272 configured to output the determination data F based on the state of the flag memory cell and in response to the signal LAT_F applied to the output node of the second page buffer unit 234 and a reference voltage REF.

The sensing unit 272 may include a current sensing circuit. In this case, the sensing unit 272 may compare the level of the signal LAT_F applied to the output node of the second page buffer unit 234 with the reference voltage REF, and outputs the comparison result as the determination data F. The sensing unit 272 may alternatively or additionally include any other types of sensing circuits known in the art.

During a read operation for a plurality of flag memory cells, data read from each of the flag memory cells may be stored in the corresponding latch (not illustrated) of the second page buffer unit 234. As flag data are stored in the respective latches, the amount of current flowing in the latch stage may be compared with the amount of current flowing while the reference voltage REF is being supplied. Based on the comparison result, the determination data F are outputted as a logic high level or logic low level.

In this exemplary embodiment, when the flag data are inputted, the main data input line is used. Therefore, the flag data input line may not be required, and an input control circuit for inputting the flag data may also be omitted.

Further, when the flag data are outputted, a current sensing circuit is used to compare an output signal of the page buffer unit provided for the flag data with the level of the reference voltage. Therefore, a multiplexer for sequentially outputting the flag data, an output unit for providing an output signal of the multiplexer, and a determiner for receiving the flag data provided from the output unit and determining the state of the flag data based on the majority decision principle may be omitted.

FIG. 5 is a conceptual diagram explaining an exemplary flag data input/output method according to one exemplary embodiment.

First, a flag data input method for writing flag data FD_IN to the flag memory area 214 will be described. When a flag data input signal PBSEL_FLAG and an address signal ADD are inputted from a host (not illustrated) to perform a flag data write operation, the controller 260 may generate a selection signal YFLAGPASS for selecting the second page buffer unit 234. When the selection signal YFLAGPASS is enabled, the second page buffer unit 234 programs the flag data FD_IN inputted through the input/output control unit 240 to the flag memory area 214.

Next, a flag data output method for determining the state of flag data from the data programmed in the flag memory area 214 will be described.

When a flag data output signal FLAGOUT_EN is enabled, the controller 260 may generate a determination circuit enable signal CSC_EN and provide the generated enable signal CSC_EN to the determination circuit 270. Furthermore, the second page buffer unit 234 reads data from the flag memory area 214 and stores the read data in a latch.

In response to the enable signal CSC_EN, the determination circuit 270 may compare an amount of current applied to the latch of the second page buffer unit 234 with an amount of current flowing while a reference voltage REF is being applied, output determination data F, and provide the determination data F to the controller 260.

In this exemplary embodiment, the flag data is inputted through the main data input line. Furthermore, when the flag data is read, the amount of current applied to the latch of the page buffer for the flag memory area is compared with the amount of current applied by the reference voltage. Based on the comparison result, the state of the flag data is determined, and the determination data are outputted.

Therefore, a data line for inputting data to the flag memory area and a data line for outputting data from the flag memory area may be omitted, which makes it possible to minimize an area occupied by the data input/output lines.

Furthermore, when the determination data are outputted from the flag data, the determination data are not outputted according to the logic level of the data written in the flag memory area, but are generated by the comparison of the current amounts. Therefore, the configuration of the determination circuit may be simplified.

As a result, the nonvolatile memory apparatus made consistent with the present disclosure may be highly integrated, and the operational efficiency of the nonvolatile memory system using the same may be improved.

While certain embodiments have been described above, it will be understood to those skilled in the art that the embodiments described are by way of example only. Accordingly, the nonvolatile memory system and the flag data input/output method described herein should not be limited based on the described embodiments. Rather, the nonvolatile memory system and the flag data input/output method described herein should only be limited in light of the claims that follow when taken in conjunction with the above description and accompanying drawings.

What is claimed is:

1. A nonvolatile memory system comprising:
a memory area comprising a main memory area and a flag memory area; and
an input/output controller configured to receive main data through a main data input line and provide the received main data to a page buffer circuit in response to a main data input control signal, the input/output controller further being configured to receive flag data through the main data input line and provide the received flag data to the page buffer circuit in response to a flag data input control signal.

2. The nonvolatile memory system according to claim 1, wherein the page buffer circuit comprises:
a first page buffer unit configured to receive and store the main data; and
a second page buffer unit configured to receive and store the flag data.

3. The nonvolatile memory system according to claim 2, further comprising an output controller configured to output state determination data of the flag data according to an amount of current applied to the second page buffer unit and in response to a flag data output signal.

4. The nonvolatile memory system according to claim 3, wherein the output controller comprises a sensing unit connected to the second page buffer unit and configured to receive a reference voltage, the sensing unit being configured to compare the amount of current applied to the second page buffer unit with an amount of current applied by the reference voltage, and output a comparison result.

5. The nonvolatile memory system according to claim 1, wherein the input/output controller is configured to receive data of the main memory area from the page buffer circuit and output the received data to a main data output line in response to a main data output control signal.

6. A nonvolatile memory system comprising:
a controller configured to output a control signal, an address signal, and data according to an operational mode;
a memory area controlled by the controller and comprising a main memory area and a flag memory area;
a first page buffer unit connected to the main memory area;
a second page buffer unit connected to the flag memory area; and
an input/output controller configured to provide main data received through a main data input line to the first page buffer unit and provide flag data received through the main data input line to the second page buffer unit, according to control of the controller.

7. The nonvolatile memory system according to claim 6, further comprising an output controller configured to output state determination data of the flag data according to an amount of current applied to the second buffer unit and in response to a flag data output signal.

8. The nonvolatile memory system according to claim 7, wherein the output controller comprises a sensing unit connected to the second page buffer unit and configured to receive a reference voltage, the sensing unit being configured to compare the amount of current applied to the second page buffer unit with an amount of current applied by the reference voltage, and output a comparison result.

9. An input/output method for flag data in a nonvolatile memory system comprising a main memory area and a flag memory area, comprising:
enabling a page buffer circuit in response to a flag data input signal and an address signal, storing flag data inputted through a main data line in the page buffer circuit, and programming the data stored in the page buffer circuit into the flag memory area; and
reading the data of the flag memory area in response to a flag data output signal, storing the read data in the page buffer circuit, and outputting state determination data of the flag data according to an amount of current applied to the page buffer circuit.

10. The input/output method according to claim 9, wherein enabling the page buffer circuit comprises storing the flag data inputted through the main data line to the page buffer circuit according to control of an input/output controller configured to control an input/output operation for data of the main memory area.

11. The input/output method according to claim 9, wherein reading the data of the flag memory area comprises comparing an amount of current applied to the page buffer circuit with an amount of current applied by a reference voltage.
